(19) United States
(12) Patent Application Publication
(10) Pub. No.: US 2013/0138349 A1
(43) Pub. Date: May 30, 2013

(54) METHOD AND APPARATUS FOR GROUNDWATER BASIN STORAGE TRACKING, REMEDIATION PERFORMANCE MONITORING AND OPTIMIZATION

(71) Applicant: Mark Kram, Santa Barbara, CA (US)

(72) Inventor: Mark Kram, Santa Barbara, CA (US)

(73) Assignee: GROUNDSWELL TECHNOLOGIES, INC., Santa Barbara, CA (US)

(21) Appl. No.: 13/701,220

(22) PCT Filed: May 9, 2011
(86) PCT No.: PCT/US2011/035783

§ 371 Date: Nov. 30, 2012

Related U.S. Application Data
(60) Provisional application No. 61/333,140, filed on May 10, 2010.

(51) Int. Cl. G01V 9/02; G06F 17/00

(52) U.S. Cl. CPC G01V 9/02; G06F 17/00
USPC 702/12; 702/2

(57) ABSTRACT

A system for monitoring and display of representative parameters in a selected monitoring geography incorporates multiple sensor suites (10) deployed at selected measurement sites within a monitoring geography which provide output data. A computer (18) receives output from the sensor suites and incorporates a computational module (208) for processing of the sensor suite output data with respect to a selected model and integration and networking software (23) for selection of parameters in the computational module and display of selected visualizations of the processed data, Monitoring terminals (20) are deployed through a network (21) and connected to the computer under control of the integration and networking software. The terminals communicate with the computational module and receive and display results from the computational module.

### REFERENCE TO RELATED APPLICATIONS

This application claims priority of U.S. Provisional Application Ser. No. 61/333,140 filed on May 10, 2010 by Mark Kram entitled METHOD AND APPARATUS FOR GROUNDWATER BASIN STORAGE TRACKING, REMEDIATION PERFORMANCE MONITORING AND OPTIMIZATION the disclosure of which is incorporated here by reference. This application is copending with application Ser. No. 12/952,504 filed on Nov. 23, 2010 which is a continuation-in-part application of application Ser. No. 11/857,354 filed on Sep. 18, 2007 entitled INTEGRATED RESOURCE MONITORING SYSTEM WITH INTERACTIVE LOGIC CONTROL having a common assignee with the present application the disclosure of which is incorporated herein by reference.

### BACKGROUND OF THE INVENTION

1. Field of the Invention

This invention relates generally to the field of automated systems for monitoring of ground water resources and contamination and particularly to a system employing a computation engine having web connectivity with capability for data accumulation and visualization or posting via a network for controlled distribution for individual and multiple ground water basins with storage, composition, velocity and contaminant solute flux visualization and quantification.

2. Description of the Related Art

Monitoring of ground water storage basins for quantity of stored water and the change in stored volumes is becoming of critical interest. Over-pumping of ground water is becoming more and more commonplace. This is especially true in arid regions of the Southwest United States. A recent GAO report claims that 36 states will encounter severe water shortages within 10 years [and this was published 7 years ago]. U.S. Government Accountability Office, Freshwater Supply: States' Views of How Federal Agencies Could Help Them Meet the Challenges of Expected Shortages,” GAO-03-514, July 2003, p 1)] An automated interactive monitoring and modeling system is required to provide managers of groundwater storage basins with continuous understanding of the dynamic interactions created by ground water extraction activities and natural processes for revitalization of the basins including impact on surface water, salt water intrusions into storage basins, interactions with surface water bodies and other environmental impacts. Additionally the requirement for monitoring of contaminant introduction and diffusion through monitored water basins (or other selected monitoring geographies) and accurate assessment of remediation performance is critical to ensuring continued long term viability of ground water storage basins. Furthermore, understanding the distribution and magnitude of mass flux and cumulative discharge of mobile nutrients is essential for being able to properly respond to harmful and unsustainable ecological conditions.

It is therefore desirable to provide systems and methods to monitor and visualize ground water resources and contaminant composition and migration based on the integration of sensors with computing capability incorporating an understanding of the hydrogeological modeling of the basin or study area as well as model adjustments based on real time data for correction of modeling assumptions, historical archiving, and implementation of actions promoting optimized resource management.

### SUMMARY OF THE INVENTION

The embodiments of the present application describe a system for monitoring and display of representative parameters in a selected monitoring geography. Multiple sensor suites are deployed at selected measurement sites within a monitoring geography and provide output data. A computer receives output from the sensor suites and incorporates a computational module for processing of the sensor suite output data with respect to a selected model and integration and networking software for selection of parameters in the computational module and display of selected visualizations of the processed data. Monitoring terminals are deployed through a network and connected to the computer under control of the integration and networking software. The terminals communicate with the computational module and receive and display and archive results from the computational module.

### BRIEF DESCRIPTION OF THE DRAWINGS

These and other features and advantages of the present invention will be better understood by reference to the following detailed description when considered in connection with the accompanying drawings wherein:

FIG. 1A is a block diagram showing the physical elements of an exemplary embodiment and its functional control elements;

FIG. 1B is a block diagram of selected operational elements of the integration and networking software package;

FIGS. 2A, 2B and 2C are display representations of functionality of a first implementation for ground water basin storage tracking;

FIGS. 3A and 3B are display representations of functionality of a second implementation for ground water seepage velocity and contaminant flux distributions, respectively;

FIG. 4 is a block diagram conceptualization of contaminant flux calculation to demonstrate that concentration (colored) is different than flux (proportional to vector length, and dependant upon both concentration and velocity);

FIG. 5 is a flow chart of exemplary contaminant flux monitoring methods employing the embodiments;

FIG. 6A is a display representation of vector depicted contaminant flux generated by the system;

FIG. 6B is a display representation of a 3D depiction of the contaminant flux shown in FIG. 6A;

FIGS. 7A, 7B and 7C are display representations for an exemplary implementation for automated remediation performance monitoring (and playback visualization);

FIGS. 8A and 8B are map and graph display representations for generalized implementations of the embodiments;

FIG. 9A is a display representation for a graph display of contaminant sensor data over time;

FIG. 9B is a display representation of the model calibration output function, where time-stamped grid values can be visualized and exported in tabular format for model calibration and optimization.

FIG. 10 is a block diagram of the system functionality for multiple sites and functions.

### DETAILED DESCRIPTION OF THE INVENTION

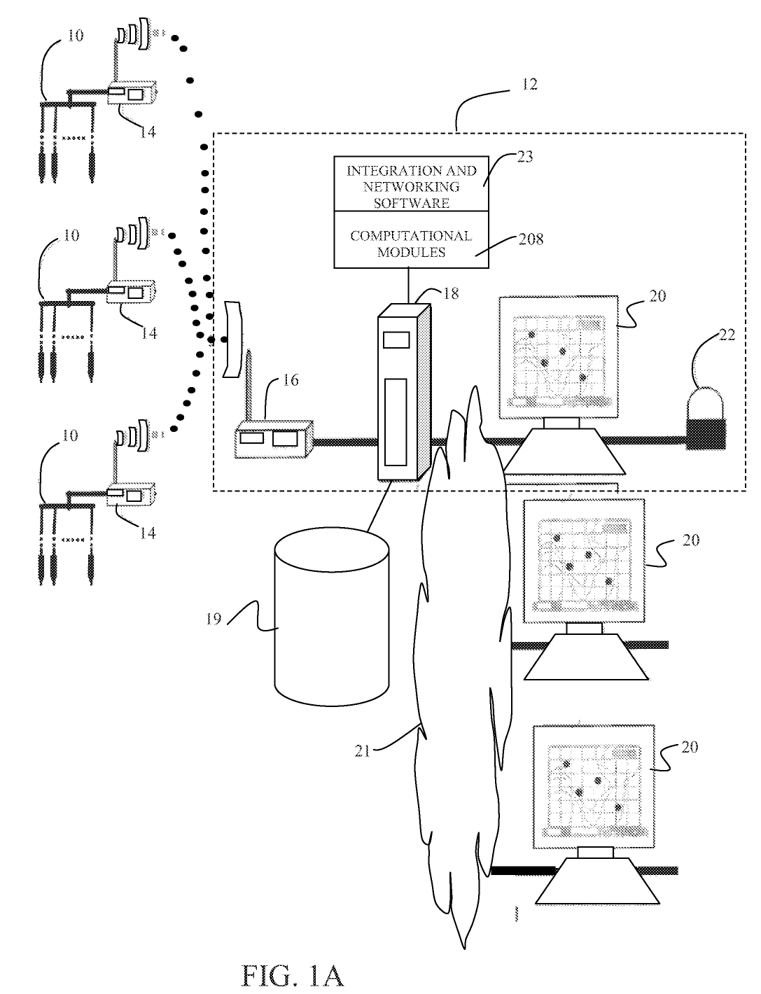

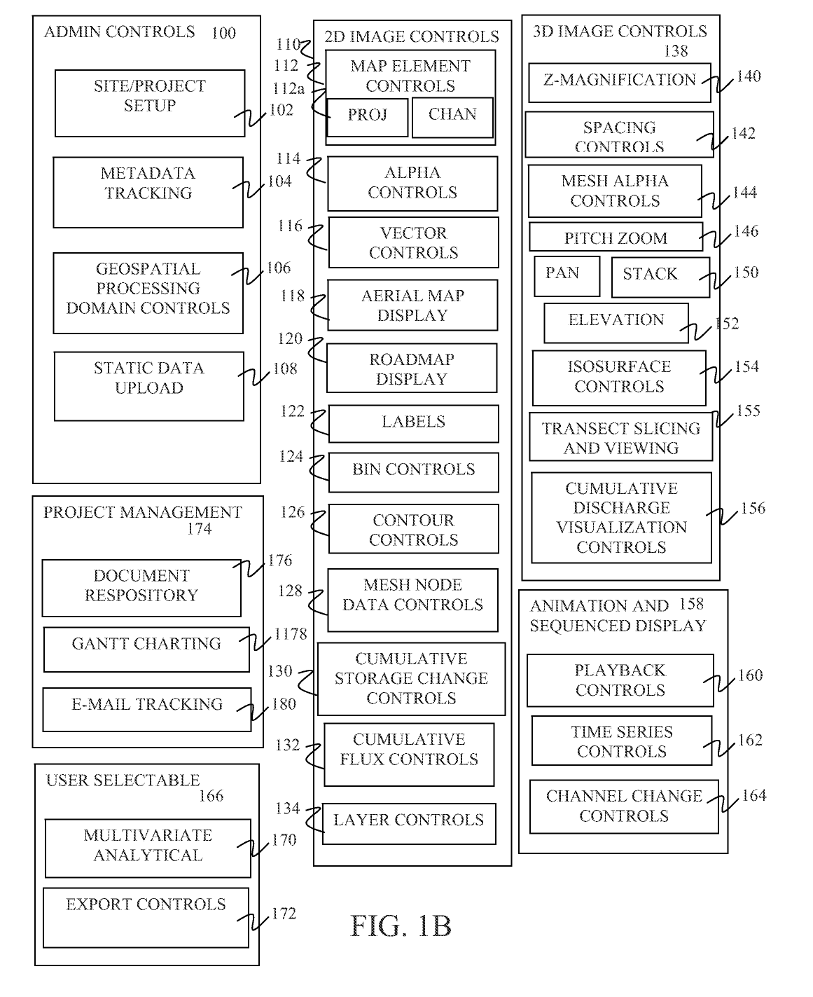

Referring to the drawings, FIG. 1 shows the elements of an embodiment of the present invention. Field sensors 10 are placed at the various wells or other measurement sites in the basin or selected monitoring geography. The sensors themselves may include such devices as flow meters, temperature sensors, pressure sensors, pH sensors, dissolved oxygen sensors, level sensors, trichloroethylene (TCE), hexavalent chromium, carbon tetrachloride, nitrogen based explosives, strontium 90, Nitrate, Geochemistry, Vapor Chemistry, biological oxygen demand (BOD), chemical oxygen demand (COD), and other physical and chemical parameters which indicate the condition of the monitoring sites under study. Many commercially available multi-sensor platforms can be deployed in conjunction with the embodiments described to simultaneously monitor for water level, dissolved oxygen, redox potential, iron species, nitrogen species, and contaminant concentration. Several solid state sensors (e.g., ion selective electrodes) can be deployed in-situ. While most of the commercially available sensors are connected to telemetry units via cable, others can transmit data to a central datalogger telemetry unit via wireless transmission.

The system allows multiple wells or measuring sites to be monitored resulting in multiple sets of field sensors as shown. In most cases the field sensors will be remote from a control center generally designated as 12 which houses the control and reporting elements of the system. Telemetric systems such as transmitters 14 at or near each measuring site and receivers 16 residing at the location of the control center effect data transfer from the sensors. Data can also be directly delivered to the Internet by the field sensors for retrieval by the control center. The representation in the drawings provides for radio transmission, however, in actual embodiments telemetry transmission approaches truly be of any applicable form known to those skilled in the art. Automated control of the multiple sensor suites is implemented in exemplary embodiments as disclosed in U.S. Pat. No. 6,915,211 issued on Jul. 5, 2005 entitled GIS BASED REAL-TIME MONITORING AND REPORTING SYSTEM the disclosure of which is incorporated herein by reference.

A computer 18 for processing of the telemetered sensor data is provided including integrated Geographic Information System (GIS) capability or other automated spatial data processor for calculation of geographically dependent parameters based on location of the measurement sites as will be described in greater detail subsequently. A storage system 19 is provided for access by the computer to store received sensor data for real time and/or historical data processing. Display terminals 20 are provided as shown in the figure and may include multiple physical display screens or elements interconnected through the internet or other network 21 for distributed monitoring and decision making based on system output as will be described subsequently. In addition to the display terminals or as an integral presentation on the terminal displays a warning/alarm system 22 is provided. In alternative embodiments, automatic dialing of telecommunications devices such as cell phones or pagers is also accomplished, as is engagement of supervisory control and data acquisition (SCADA) systems.

System configuration and operational components are controlled through an integration and networking software package 23 including computational modules resident in the computer or server. Through this package, a user can select the type of sensor and telemetry system used, establish display options (e.g., background map, symbol and map elements, contour options, time series analyses, color scheme, etc.), control the frequency of data collection, the geostatistical data treatment options, and engage models, alarms, and emergency response protocols.

As shown in FIG. 1B, the integration and networking software package provides an implementation of the method of the present invention on the computer and terminals and includes modules with both graphical elements for creation and manipulation of the display presented to the users on the terminals and control elements for computation and processing of the data from the sensors. General administrative controls are also included.

As shown in block diagram form in FIG. 1B and as displayed on the monitors in figures discussed subsequently, the administrative controls 100 include elements such as site/project setup 102 which provides entry of administrative data regarding the site or project which is monitored by the system, meta data tracking 104, geospatial processing domain controls 106 for defining the spatial extents of the project and static data upload 108 which allows insertion of constraint data for the system.

2D image controls 110 for creation and presentation of images on the on the terminals include map element controls 112 such as project 112a, channel 112b alpha controls 114, vector controls 116, aerial map display 118, roadmap display 120, labels 122, bin controls 124, contour controls 126, mesh node data controls 128, cumulative storage change controls 130 and cumulative flux controls 132. Layer controls 134 provide for selected display of individual elements such as monitoring site locations, contours and other mapping symbology.

3D image controls 138 are also provided such as Z-magnification 140, spacing controls 142, mesh alpha controls 144, pitch zoom 146, pan 148, stack, 150 elevation 152, isosurface controls 154, transect slicing and viewing controls 155 and cumulative discharge through a transect visualization controls 156.

Animation and sequenced display controls 158 are provided such as playback controls 160, time series controls 162, and channel change controls 164. User selectable controls 166 are provided for the type of analysis conducted by the computational modules such as multi-variate analytical controls 170. Controls for data handling of stored results are also provided such as export controls 172.

Project management features 174 within the package may include document repository or library 176, forward projects tracking through geospatial links to Gantt charts 178, and email tracking 180. The entire data tracking and reporting system can be accessed from the terminals through password-protected web subscription, so no software downloads are required for individual users.

In one exemplary implementation of an embodiment as a groundwater basin storage tracking (GBST) system for water supply management and optimization, monitoring of basin water levels, determination/reporting of changes to levels and determination/reporting of changes in storage can be accomplished. The system output with centralized web based report distribution then provides resource managers with real-time, decision-quality information and automated responses (real-time rate adjustment) can be implemented. The data storage capability of the hydrogeologic system provides a historical record and reporting system for the basin. Future allocation and comprehensive watershed management planning may be accomplished.

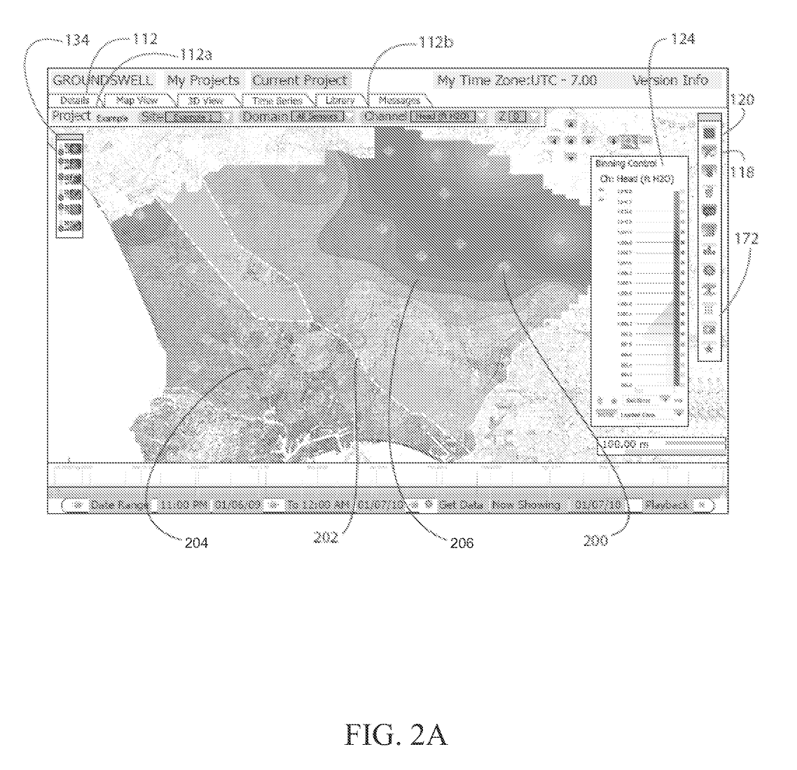

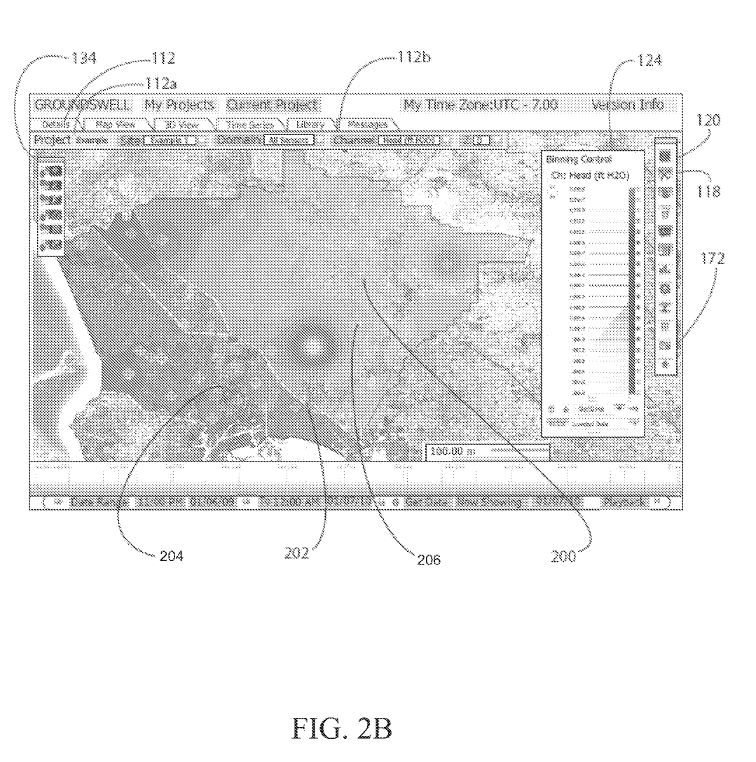

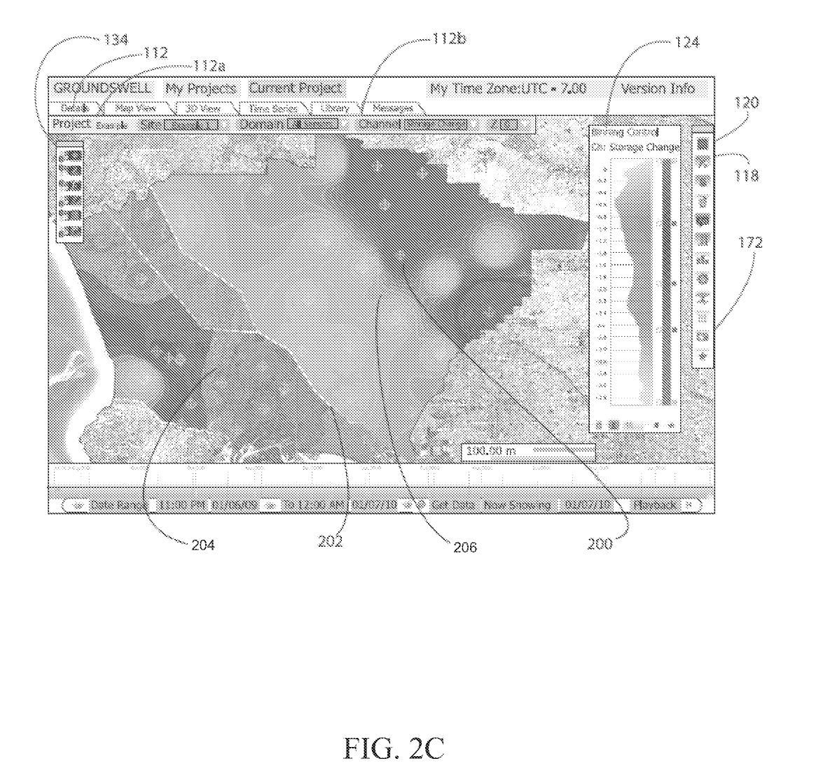

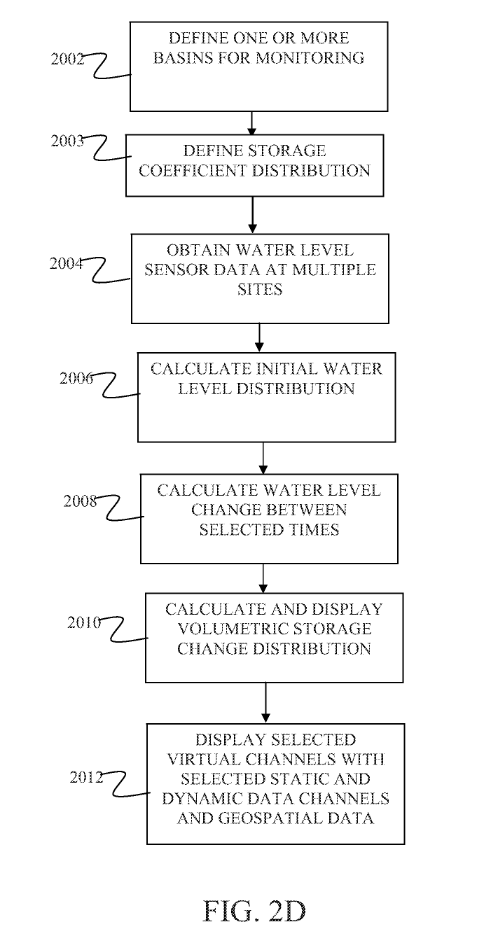

As shown in FIGS. 2A, 2B and 2C, the GBST employs water love sensor data at multiple well locations 200 as the measurement sites to calculate and display an initial water love distribution (ground water elevation as the selected channel 112b) shown in FIG. 2A The interpolation is calculated using geostatistical analyses selected from the multi-variate analytical controls 170 that may include inverse distance weighting, kriging, or other selected calculation alternatives, water level change (ground water change as the selected channel 112b) between selected times shown in FIG. 2B, and volumetric storage change (as selected channel 112b) defined as distributions of change in water level multiplied by co-located distributions of storage capacity, shown in FIG. 2C. Water level changes and storage capacity distributions are automatically processed to determine storage change distributions and estimate cumulative volumetric changes for the selected time steps. Ground water divides such as faults 202 are also represented to allow for monitoring of multiple basins 204 and 206 simultaneously.

As shown in FIGS. 2A, 2B and 2C, the 2D controls available for the system are readily accessible by the user as selectable buttons displayed on the monitor.

Calculated or virtual channels such as distribution of the water in the basin are determined in the system by a computational module 208 (shown in FIG. 1A as a portion of the software incorporated in the computer) for calculating transmission of the water through the basin or other monitoring geography. For the embodiments shown, an initial model for velocity and concentration distributions is created using conventional data collection approaches. Initial hydraulic information and concentrations can be accomplished in the measurement sites using sensors such as high resolution piezocone/membrane interface probes and conventional analyses of data and strata from wells and borings. The computational module then solves, as an exemplary model, Darcy's Law in three dimensions (3D) (hydraulic conductivity, effective porosity, head and gradient distributions) to determine Darcy velocity and seepage velocity distributions. When multiplied by co-located concentration values, contaminant flux distributions may be determined, as will be described in greater detail subsequently. Display of the calculated data is then provided and updated using automatic timed measurement by the sensors at the measurement sites.

Computations conducted by the computational module include both static data sets (e.g., hydraulic conductivity and effective porosity) and dynamic data sets (e.g., hydraulic head and concentration) which can also be displayed by the system as selectable channels. Actual measurements may then also be employed to update the parameters of the initial model by iterative measurement and processing of collected sensor data. Other static data may be input into the computational model. A seasonal change observation, or a percentage of the mass removal due to natural or anthropogenic factors are quantified and monitored in an automated configuration. A conventionally derived fate and transport predictive model provides a quantified model prediction of parameters that are measurable in space and time that can later be evaluated once the data at the specific location at that particular time is either observed or estimated based on an interpolation using the system. Predictive models can then be revised to reduce discrepancies between predictions and observations. This approach enables Water Masters, remediation professionals and other responsible parties to closely monitor the resource and generate and post reports in a timely manner. Conventional approaches currently require weeks to months to calculate a single incremental basin storage result, while the present embodiment enables managers to obtain these types of critical reports in a matter of seconds from anywhere with an Internet connection. For remediation performance monitoring, flux conceptualization results often are not processed and visualized for three to six months from the time field data is collected using conventional approaches, while the present embodiment enables remediation managers to access these reports in seconds.

Shown for water levels in the prior example, multi-sensor platforms as described with respect to FIG. 1A can be deployed at the well locations and contour maps for each sensor type can be automatically generated at virtually any time step of interest. Furthermore, combined sensor data sets (e.g., contaminant concentration and redox potential) can be automatically mapped using geospatial analytical capabilities within the GIS as will be described in greater detail subsequently.

FIG. 2D provides an exemplary flow chart of the operation of the system in calculation and display of the GBST system. The method for monitoring and display of groundwater parameters in a selected monitoring geography is accomplished by defining one or more groundwater basins for monitoring, step 2002. Storage coefficient distribution is defined in step 2003 and water level sensor data is then obtained at multiple well locations as measurement sites within each basin, step 2004. An initial water level distribution is calculated between the well locations, step 2006. Water level change distribution is then calculated between the well locations between selected times, step 2008. The volumetric storage change distribution can then be calculated between the well locations, step 2010. Each of the calculation is accomplished with multi-variate analytical controls selected by the user. The calculated data as virtual channels is then displayed with static and dynamic data channels and geospatial data as selected by the user, step 2012.

In a second example implementation of an embodiment, groundwater seepage velocity distributions determined by sensor based water levels are displayed. Previously estimated hydraulic conductivity and effective porosity distributions, which are static data channels, are used to automatically generate velocity distributions as a virtual channel every time water level sensor readings are processed by the system as dynamic data channels.

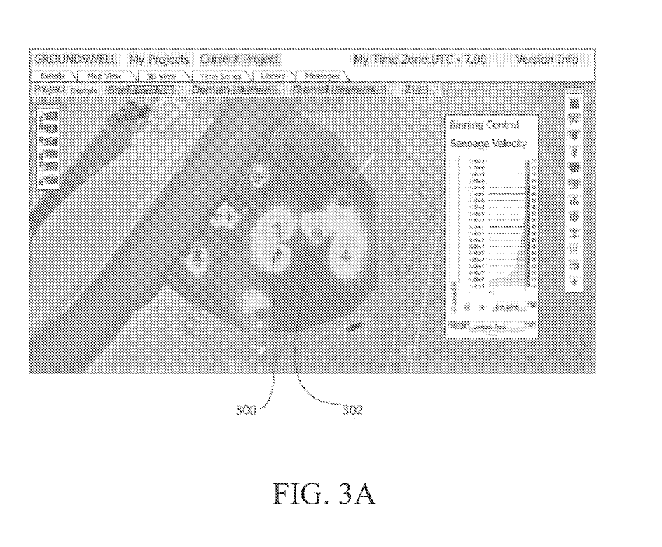

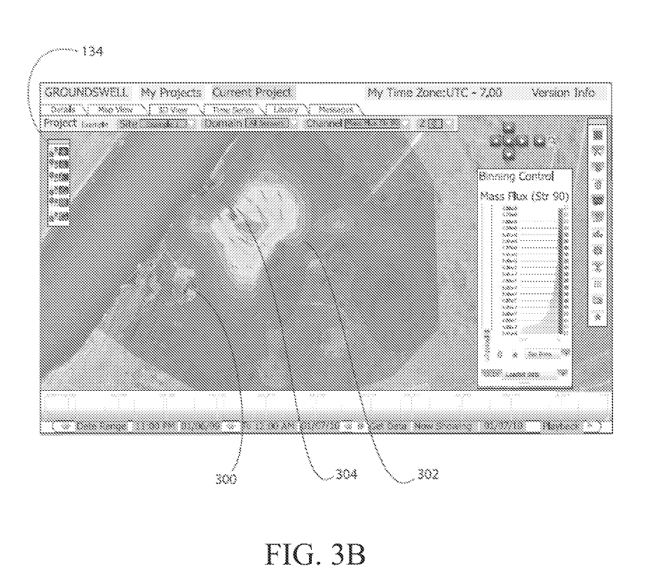

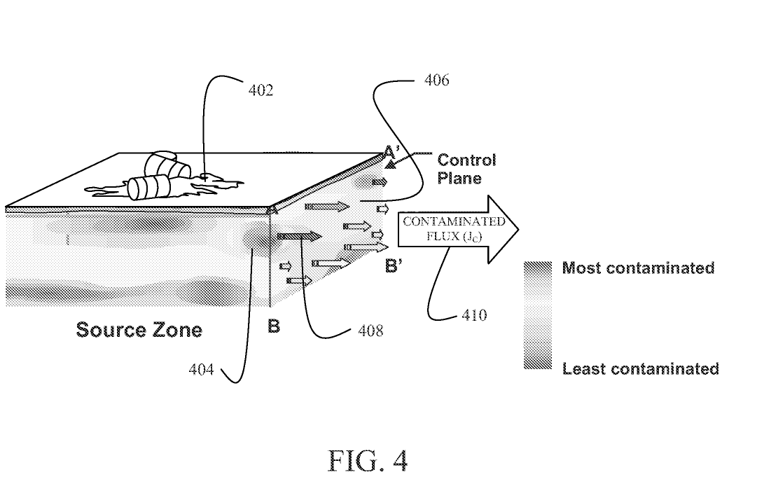

FIGS. 3A and 3B demonstrate exemplary outputs of the implementation. FIG. 3A shows relative low seepage velocity relative to well locations 300 as shaded contours 302. FIG. 3B provides an added visualization of contaminant flux by using vector directional indicators 304. Indicators 304 are vector in nature with magnitude and direction for representation of the mass movement. Vector location and magnitude are created by the system through user settings. Settings include mesh granularity, bounding processing domain size as a percentage beyond the length of a domain defined by the extreme locations of the bounding wells; cell height (if 3D) and grid size, anisotropy, z-magnification, and other features that define each node over which a vector would be displayed. Each vector takes into account the nearest neighbor in space to determine the direction and length. The visualization shown in FIG. 3B includes both the vectors and contours for contaminant seepage velocity as selected by the layer controls 134. As shown, the layers selected include the monitoring site locations can be displayed with/without the color contours. FIG. 4 is a block diagram of flux modeling of contaminants from spills 402 or other sources. Contaminants seep into geologic features which provide various concentration levels designated by contours 404. A control plane 406 is established for the model and the system employs the computational model for calculating transmission of the contaminants through the monitoring geology. User determined contaminant levels may be selected and the flux of those relative levels individually represented as vector values 408 whose length is proportional to concentration times velocity. A cumulative flux value (or mass discharge, in units of mass/time) for the control plane transect may also be calculated 410 for each time step. This can be tracked over time to evaluate remediation effectiveness (e.g., mass discharge reduction through the source control plane). This cumulative scalar value (in units of mass per time) for each time step can be plotted as a time series to estimate the amount of change in mass movement. In addition, multiple control planes can be monitored simultaneously to enable practitioners to evaluate natural and anthropogenic attenuation of the source strength.

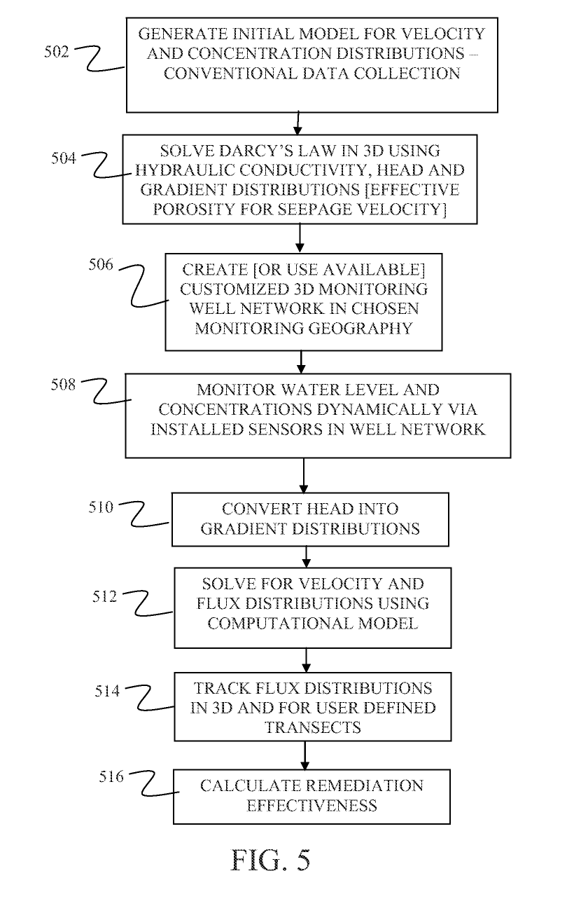

The method accomplished by the system is shown in FIG. 5. An initial model is generated for water level and concentration distributions based on conventional data collection approaches in step 502. Darcy's Law is then solved in 3D using hydraulic conductivity, head and gradient distributions in step 504. Seepage velocity distribution can also be rendered by incorporating effective porosity. An initial mass flux distribution is also rendered by multiplying the initial concentration distribution by the initial co-located velocity values.

A customized 3D monitoring well network is then created in the chosen monitoring geography in step 506. The sensor suites may include high resolution flow meters, temperature sensors, pressure sensors, pH sensors, dissolved oxygen sensors, level sensors, TCE, Cr(VI), C-Tet, N-Explosives, SR90, Nitrate, Geochemistry, Vapor Chemistry, BOD, COD, and Vapor constituents in the vadose zone.

Water Level and Concentrations are then monitored dynamically via the sensors in step 508. Head is converted into gradient distributions in step 510 and the computational model then solves for Velocity and Flux Distributions in step 512.

Flux Distributions are then tracked in both 3D and for specific user defined transects in step 514. Remediation effectiveness based on plume status (stable, contraction, etc.) is then calculated with a user defined remediation metric in step 516.

For the described embodiment, seepage velocity (ν) is calculated as

ν=Ki/ρ

where: K=hydraulic conductivity, i=hydraulic gradient and ρ=effective porosity.

The contaminant flux is then determined as

F=ν[X] (mass/length2−time; mg/m2−s)

where: ν=seepage velocity (length/time; m/s) and [X]=concentration of solute (mass/volume; mg/m3). Darcy velocity can also be used in lieu of seepage velocity for the flux and mass discharge calculations and visualizations.

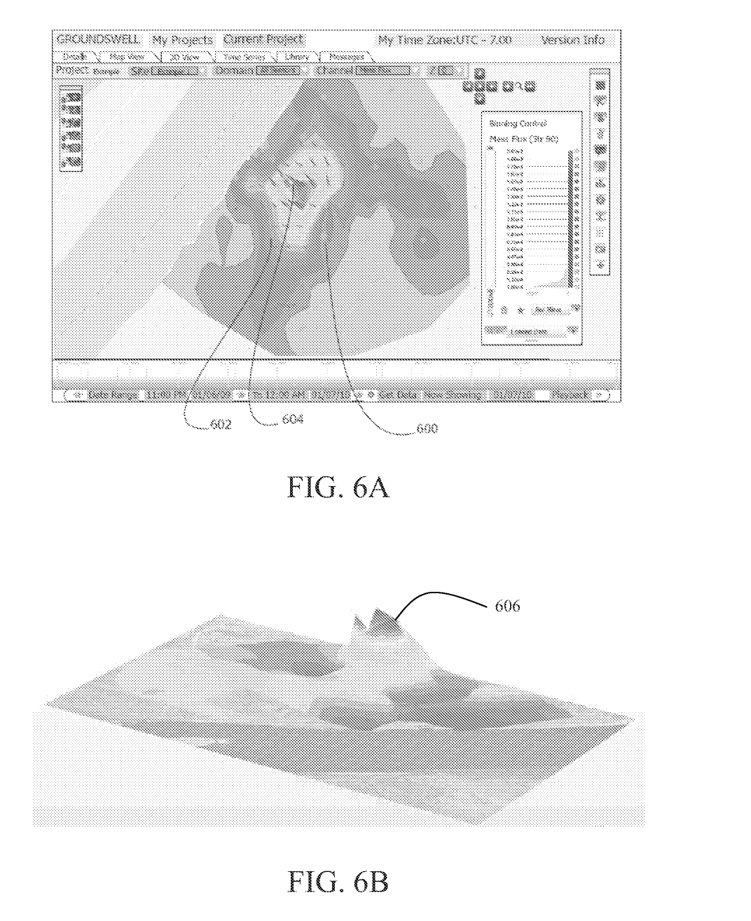

A visualization the measurement sites 600 as shown in FIG. 6A may then be provided by the system to the displays wherein contours 602 show the distributions of contaminant flux, and the vectors 604 show the contaminant flux tendency directions as calculated. Various contaminant channels 112b (Strontium for the example shown) may be separately displayed using color coding or similar indicia and various user selected combinations of overlay or total combined concentrations may shown using the layer controls 134 and employed for the remediation effectiveness determination. Concentration measurements can be automatically converted to mass discharge estimates for automated remediation performance monitoring. FIG. 6B shows a 3D visualization 606 of the distributions of the contaminant flux.

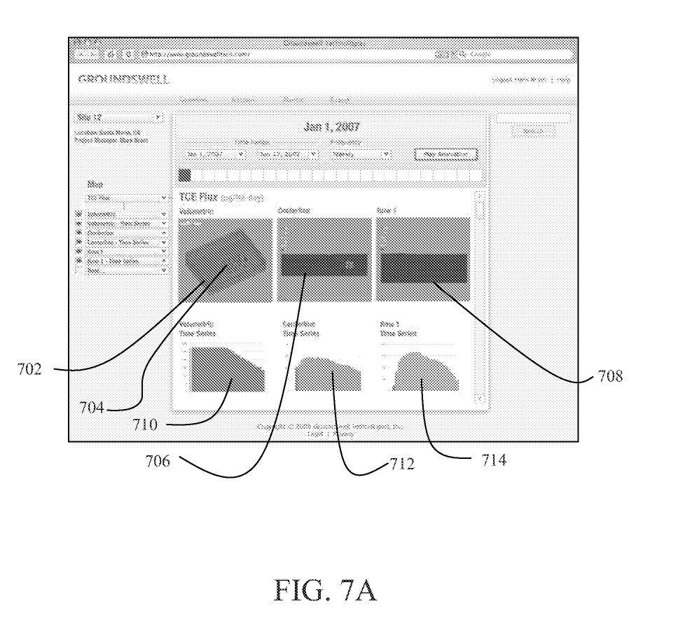

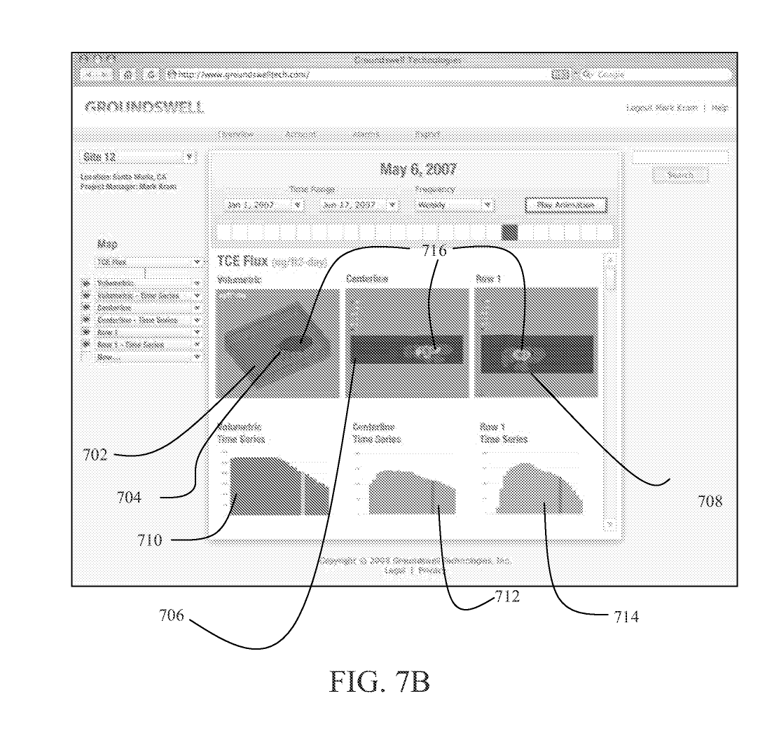

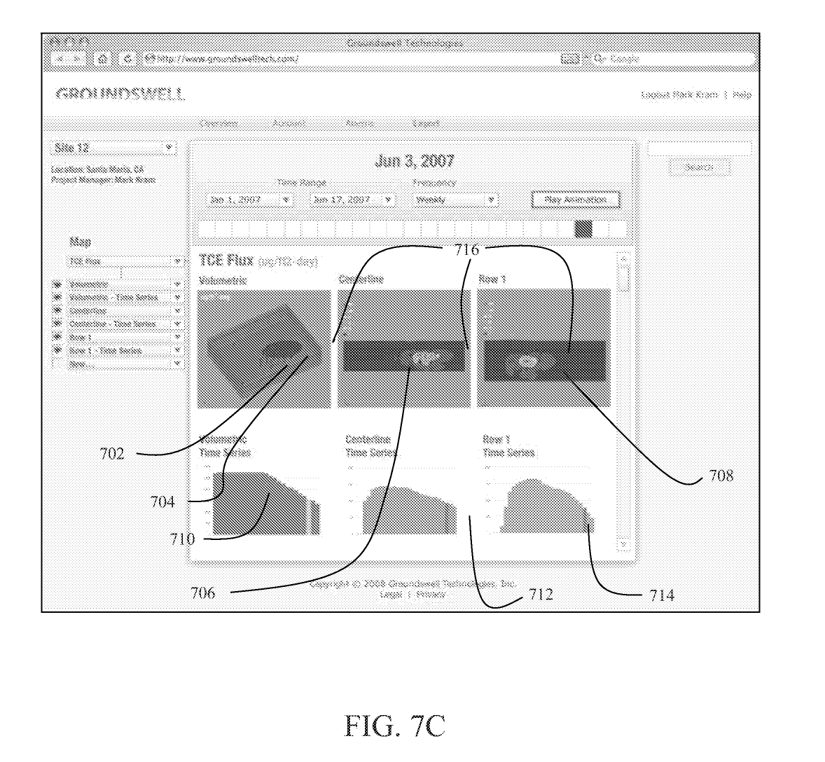

FIGS. 7A, 7B and 7C show an exemplary output display format from the system for time sequenced remediation performance monitoring. FIG. 7A shows an initial condition with a selected monitoring geography 702 represented in 3D depicting the monitoring sites 704 for the sensor suites. Contaminant flux distribution is depicted in 3D and selected transects; centerline 706 and row 1 708. The computational system then allows definition of transects for display of the sensor output and calculation of contaminant flux. As shown the first transect 706 along the centerline runs in the direction of flow roughly from right (NE) to left (SW) through the center of the domain and the well field and a second transect 708 along row 1 oriented perpendicular to flow and parallel to the first row of wells allow visualization of the contaminant migration. Histograms 710, 712 and 714 show time series values for the selected contaminant channel for the total volume, centerline transect and row 1 transect respectively and display the cumulative flux (mass discharge) moving through the volume and selected transects for the time steps measured. FIG. 7B shows the 3D, centerline transect and row 1 transect at a second time increment within the time series and FIG. 7C shows the data for a third time increment. The display system allows animated time sequence display for visualization of the blossoming plume 716 and remediation effects. Selection of various transects allows visualization of the migration as measured by the sensor suites and calculated by the system with displays of velocity, flux and discharge as previously described.

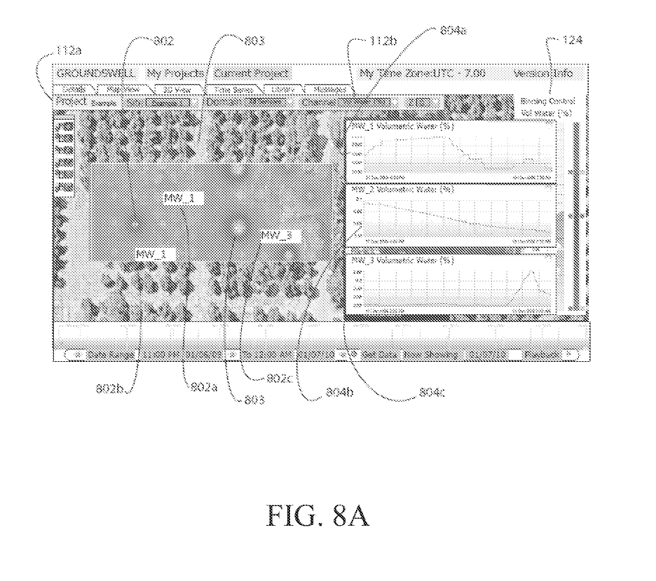

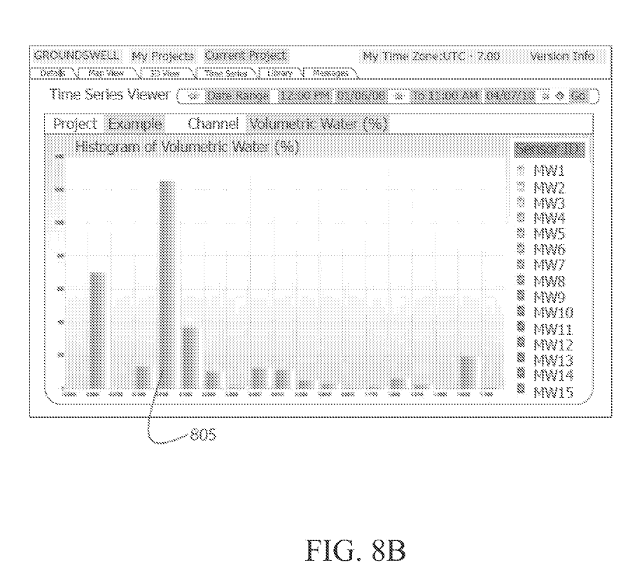

The embodiments of the system may be employed in a generalized case for any desired set of measured parameters from deployed sensor suites for any chosen monitoring geography. As shown in FIGS. 8A, 8B and 8C various generalized parameter sets or channels may be created based on the sensor types and locations in the monitoring geography. FIG. 8A demonstrates an implementation for a moisture content measurement system in an orchard or vineyard. Multiple sensors suites 802 are deployed in an orchard 803. Each sensor provides a measurement of volumetric water content as channel 112b. Three specific time value graphs 804a, 804b and 804c of sensors 802a, 802b and 802c are shown. As a mouse hovers over the time series graph, information about that data point is posted. Visualization of the concentrations surrounding each site are shown as contours 803 in the pictorial 211) visualization selected by Map View control.

FIG. 88 shows an alternative specific time display with volumetric water (moisture) content at each of the 25 sensor sites shown in bar chart format 805 for the selected time or range of times.

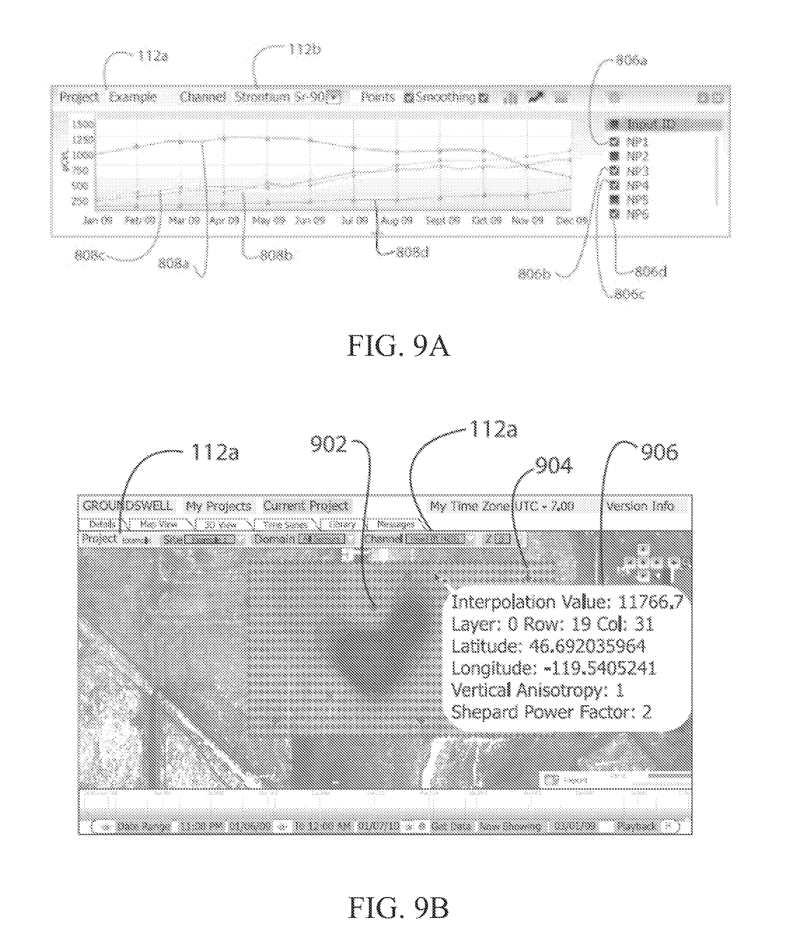

FIG. 9A demonstrates a second alternative implementation with similar time sequence display for values of strontium 90 as the selected channel 112b in a sensor suite field surrounding a nuclear facility selected as the project 112a with time varying values of four specific sensors NP1 806a, NP3 806b, NP4 806c and NP6 806d selected to be shown and providing time value graphs 808a, 808b, 808c and 808d respectively.

FIG. 9B shows alternative channel selection for chromium Cr(VI) contours in a map format showing the actual measurement sites 902, the calculation nodes 904 associated with the applied multi-variate analysis for the desired virtual channels displayed and associated node interpolation values 906 that can be exported for comparison with modeled values (e.g., model calibration and optimization).

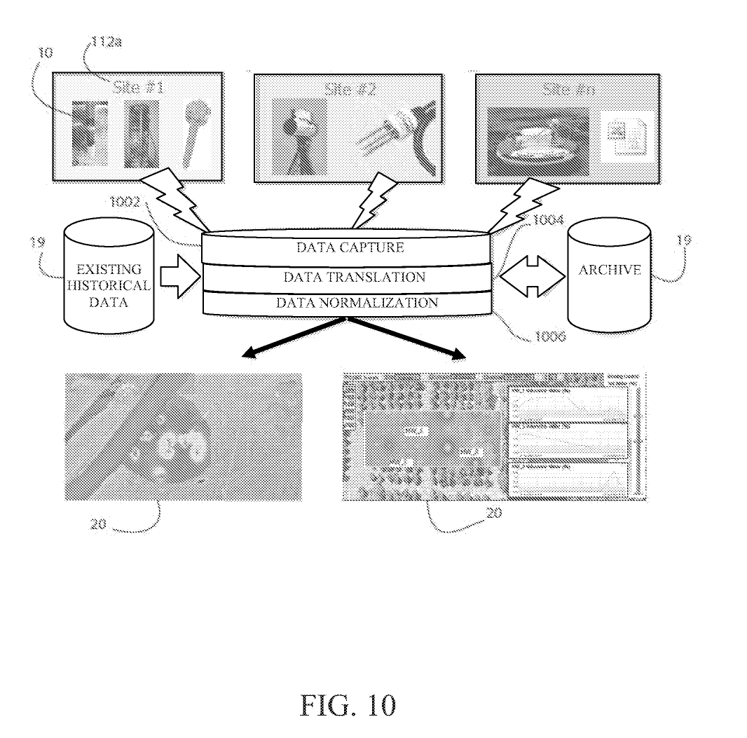

FIG. 10 is a generalized block diagram of the functionality of the system described in the embodiments herein. Sensor packages 10 for the various project sites selectable by the system as projects 112a, provide data which is captured 1002 by the integration and networking software 23. The computational models 208 create data translation 1004 as selected by the user appropriate for the data and merge historical data from storage 19 for time history analysis to provide data normalization 1006 for presentation by the system on the monitors 20 as appropriate for the selected project site. The updated data is then archived back into storage. The system allows complete flexibility in defining the sensor inputs, calculations accomplished by the computational modules, the display visualizations for each project independently.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A system for monitoring and display of representative parameters in a selected monitoring geography comprising:
a plurality of sensor suites (10) deployed at selected measurement sites within a monitoring geography and providing output data;
a computer (18) receiving output from the sensor suites and having
a computational module (208) for processing of the sensor suite output data as dynamic data channels with respect to a selected model of static data channels to provide virtual channels and
integration and networking software (23) for selection of parameters in the computational module and display of selected visualizations of the processed data from the static, dynamic and virtual channels; and,
a plurality of monitoring terminals (20) deployed through a network (21) and connected to the computer under control of the integration and networking software to communicate with the computational module and receive and display results from the computational module, said computational module responsive to a plurality of selectable channels and controls (100, 110, 138, 158, 166) for the results to be displayed.

2. The system as defined in claim 1 wherein the computational module (208) includes means for defining transects for output of data.

3. The system as defined in claim 1 wherein the computational module (208) includes means for vector display of data as processed by the model.

4. The system as defined in claim 1 wherein the computational module (208) includes means for interactive adjustment of model parameters based on received output from the sensor suites.

5. The system as defined in claim 1 wherein the monitoring geography comprises a groundwater basin, a selected portion of the sensors detect water level and the model comprises Darcy's law or a modification of Darcy's law to depict seepage velocity.

6. The system as defined in claim 1 wherein the monitoring geography comprises a groundwater basin, a selected portion of the sensors detect water level and the model calculates water level distribution.

7. The system as defined in claim 3 wherein a selected portion of the sensors detect contaminant concentration and the vector display depicts contaminant flux magnitude.

8. The system as defined in claim 1 wherein the controls are selected from the set of administrative controls (100), 2D image controls (110), 3D image controls (138) and Animation and sequenced display controls (158)).

9. The system as defined in claim 8 wherein the 2D image controls include map element controls (112), alpha controls (114), vector controls (116), aerial map display (118), roadmap display (120), labels (122), bin controls (124), contour controls (126), mesh node data controls (128), cumulative storage change controls (130) cumulative flux controls (132) and layer controls (134).

10. The system as defined in claim 8 wherein the 3D image controls include Z-magnification (140), spacing controls (142), mesh alpha controls (144), pitch zoom (146), pan (148), stack (150), elevation (152) and isosurface (154) controls.

11. The system as defined in claim 8 wherein the Animation and sequenced display controls include playback controls (160), time series controls (162), and channel change controls (164).

12. A method for monitoring and display of groundwater parameters in a selected monitoring geography comprising:
defining one or more groundwater basins for monitoring;
obtaining water level sensor data at multiple well locations as measurement sites within each basin;
calculating an initial water level distribution between the well locations;
calculating water level change distribution between the well locations between selected times, and
calculating volumetric storage change distribution between the well locations.

13. The method as defined in claim 12 wherein each step of calculating includes using geostatistical analyses selected from multi-variate analytical controls selected from the set of inverse distance weighting and kriging.

14. The method as defined in claim 12 wherein water level change and storage capacity distributions are automatically processed to determine storage change distributions and estimate cumulative volumetric changes for the selected time steps

15. A method for monitoring and display of representative parameters in a selected monitoring geography comprising:
generating an initial model for water level and concentration distributions based on conventional data collection approaches;
solving Darcy's Law in 3D for hydraulic conductivity, effective porosity, concentration, head and gradient distributions;
creating a customized 3D monitoring well network in the chosen monitoring geography;
installing sensor suites in the monitoring wells;
monitoring water level and concentrations dynamically via the sensors;
converting head into gradient distributions and solving for Velocity and Flux Distributions; and
tracking flux distributions in both 3D and for specific user defined transects.

16. The method of claim 15 wherein the representative parameters comprise contaminants and the sensor suites incorporate sensors selected from the set of flow meters, temperature sensors, pressure sensors, pH sensors, dissolved oxygen sensors, level sensors, trichloroethylene (TCE), hexavalent chromium, carbon tetrachloride, nitrogen based explosives, strontium 90, Nitrate, Geochemistry, Vapor Chemistry, biological oxygen demand (BOD), chemical oxygen demand (COD), and other physical and chemical parameters.

17. The method of claim 16 further comprising calculating remediation effectiveness based on plume status with a user defined remediation metric.

18. The method of claim 15 wherein the step of tracking flux distributions further comprise automated determination of cumulative flux changes through source control planes and volumes.
